(19) United States
(12) Patent Application Publication
(10) Pub. No.: US 2025/0073870 A1
(43) Pub. Date: Mar. 6, 2025

(54) ELECTRIC TOOL SYSTEM, ELECTRIC TOOL MANAGEMENT METHOD, AND PROGRAM

(71) Applicant: PANASONIC HOLDINGS CORPORATION, Osaka (JP)

(72) Inventors: Masanori NAKAMOTO, Mie (JP); Hiroaki MURAKAMI, Kyoto (JP); Fumiaki SAWANO, Mie (JP); Motoharu MUTO, Mie (JP)

(21) Appl. No.: 18/708,133

(22) PCT Filed: Oct. 25, 2022
(86) PCT No.: PCT/JP2022/039728

§ 371 Date: May 7, 2024

(30) Foreign Application Priority Data
Nov. 19, 2021 (JP) 2021-188793

(51) Int. Cl. B25B 23/147

(52) U.S. Cl. CPC B25B 23/1475

(57) ABSTRACT

An electric tool system includes a fastening unit, a sensor unit, a torque calculator, an input unit, a comparison processor, and a correction processor. The fastening unit fastens a work target onto a specified member with driving force generated by a power source. The sensor unit detects a physical quantity corresponding to fastening torque with which the fastening unit fastens the work target. The torque calculator calculates a torque measured value by applying a result of detection of the physical quantity by the sensor unit to a calculating method. The input unit accepts entry of a torque true value. The comparison processor compares the torque measured value with the torque true value. The correction processor makes, based on a result of comparison made by the comparison processor, correction to the calculating method to make a difference between the torque measured value and the torque true value equal to or less than a predetermined threshold value.

### TECHNICAL FIELD

The present disclosure generally relates to an electric tool system, an electric tool management method, and a program. More particularly, the present disclosure relates to an electric tool system, an electric tool management method, and a program, all of which enables measuring a fastening torque value.

### BACKGROUND ART

Patent Literature 1 discloses a tool system. The tool system includes a tool and a management device.

The tool is used to perform an operation on a work target. The tool includes: a fastening unit driven by a power source to fasten the work target onto a specified member; a sensor for measuring at least one of vibration or sound produced by the fastening unit; and an output unit for outputting the result of measurement made by the sensor.

The management device manages the condition of the tool. The management device determines the condition of the tool based on the result of measurement provided by the tool.

In the field of electric tools such as the one disclosed in Patent Literature 1, there is a growing demand for improving the reliability of a torque measured value measured by the electric tool.

### CITATION LIST

### Patent Literature

Patent Literature 1: JP 2018-122429 A

### SUMMARY OF INVENTION

In view of the foregoing background, it is therefore an object of the present disclosure to provide an electric tool system, an electric tool management method, and a program, all of which may contribute to improving the reliability of the torque measured value.

An electric tool system according to an aspect of the present disclosure includes a fastening unit, a sensor unit, a torque calculator, an input unit, a comparison processor, and a correction processor. The fastening unit fastens a work target onto a specified member with driving force generated by a power source. The sensor unit detects a physical quantity corresponding to fastening torque with which the fastening unit fastens the work target. The torque calculator calculates a torque measured value by applying a result of detection of the physical quantity by the sensor unit to a calculating method. The input unit accepts entry of a torque true value. The comparison processor compares the torque measured value with the torque true value. The correction processor makes, based on a result of comparison made by the comparison processor, correction to the calculating method to make a difference between the torque measured value and the torque true value equal to or less than a predetermined threshold value.

An electric tool management method according to another aspect of the present disclosure includes detection processing, torque calculation processing, operating command input processing, comparison processing, and correction processing. The detection processing includes detecting a physical quantity corresponding to fastening torque with which a fastening unit fastens a work target onto a specified member with driving force generated by a power source. The torque calculation processing includes calculating a torque measured value by applying a result of detection of the physical quantity obtained in the detection processing to a calculating method. The operating command input processing includes accepting entry of a torque true value. The comparison processing includes comparing the torque measured value with the torque true value. The correction processing includes making, based on a result of comparison obtained in the comparison processing, correction to the calculating method to make a difference between the torque measured value and the torque true value equal to or less than a predetermined threshold value.

A program according to still another aspect of the present disclosure is designed to cause a computer system to perform the electric tool management method described above.

### BRIEF DESCRIPTION OF DRAWINGS

FIG. 1 is a block diagram of an electric tool system according to an exemplary embodiment of the present disclosure;

FIG. 2 illustrates a schematic system configuration for the electric tool system;

FIG. 3 is a schematic representation illustrating an exemplary electric tool for use in the electric tool system;

FIG. 4 is a schematic representation illustrating an exemplary torque measuring machine for measuring a torque true value to be supplied to the electric tool system;

FIG. 5 is a sequence chart illustrating an operating procedure of the electric tool system; and

FIG. 6 is a block diagram of an electric tool system according to a variation.

### DESCRIPTION OF EMBODIMENTS

An electric tool system 10 according to an exemplary embodiment of the present disclosure will now be described with reference to the accompanying drawings. The drawings to be referred to in the following description of embodiments are all schematic representations. Thus, the ratio of the dimensions (including thicknesses) of respective constituent elements illustrated on the drawings does not always reflect their actual dimensional ratio. Note that the exemplary embodiment and its variations to be described below are only an exemplary one of various embodiments of the present disclosure and its variations and should not be construed as limiting. Rather, the exemplary embodiment and its variations may be readily modified in various manners depending on a design choice or any other factor without departing from a true spirit and scope of the present disclosure. Note that the exemplary embodiment and its variations to be described below may be adopted in combination as appropriate.

### (1) Overview

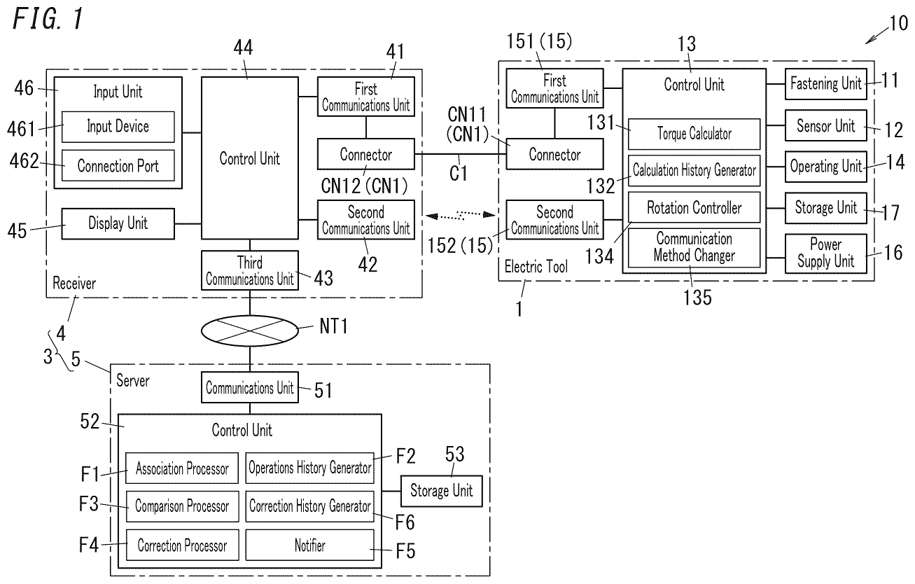

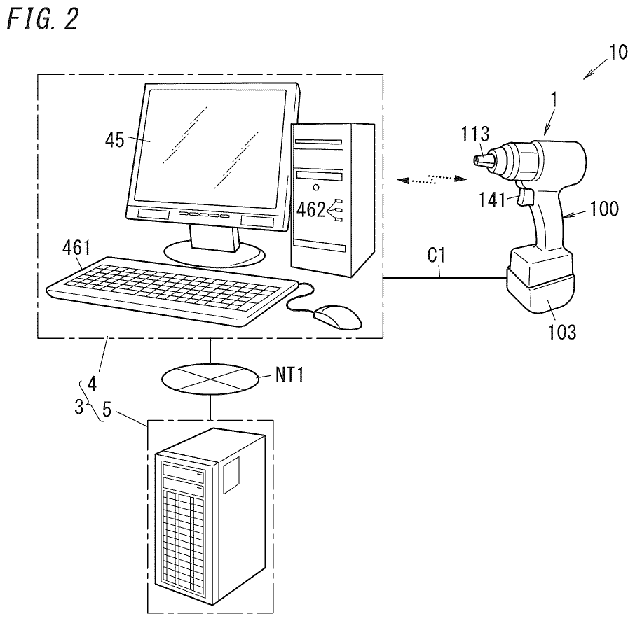

FIG. 1 is a schematic block diagram of the electric tool system 10. FIG. 2 illustrates a schematic system configuration for the electric tool system 10.

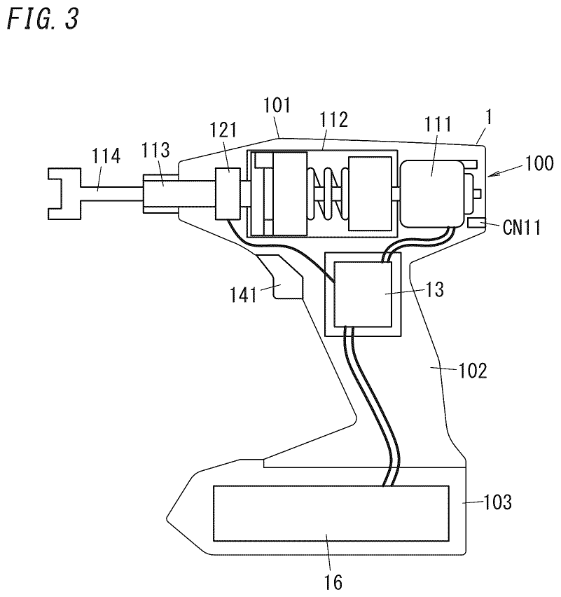

As shown in FIGS. 1 and 2, the electric tool system 10 includes a fastening unit 11, a sensor unit 12, a torque calculator 131, an input unit 46, a comparison processor F3, and a correction processor F4. The fastening unit 11 fastens a work target onto a specified member with driving force generated by a power source (such as a motor 111 (refer to FIG. 3)). The sensor unit 12 measures a physical quantity corresponding to fastening torque with which the fastening unit 11 fastens the work target. The torque calculator 131 calculates a torque measured value by applying a result of measurement of the physical quantity by the sensor unit 12 to a calculating method. The input unit 46 accepts entry of a torque true value. The comparison processor F3 compares the torque measured value with the torque true value. The correction processor F4 makes, based on a result of comparison made by the comparison processor F3, correction to the method for calculating the torque measured value for use in the torque calculator 131 to make the difference ΔT between the torque measured value and the torque true value equal to or less than a predetermined threshold value (first threshold value ΔTh1).

As used herein, the “physical quantity corresponding to the fastening torque” refers to a physical quantity that varies according to the value of the torque applied to the work target. The physical quantity corresponding to the fastening torque may be the value of the torque applied to the fastening unit 11, the magnitude of the strain generated to the fastening unit 11 when a fastening operation is performed on the work target, or the magnitude of the strain generated to the output shaft of the motor 111, whichever is appropriate. Also, the “torque true value” as used herein refers to the value of the torque applied from the fastening unit 11 to the work target when the work target (fastening member) to be subjected to the fastening operation is fastened with a preset torque value specified with respect to the fastening operation. Furthermore, the “calculating method” as used herein refers to a calculating formula for calculating the torque measured value based on the result of measurement of the physical quantity by the sensor unit 12. Thus, “to make correction to the calculating method” as used herein includes changing the coefficients and degrees of respective terms that form the calculating formula.

According to this configuration, making correction to the calculating method to make the torque measured value closer to the torque true value enables reducing the effect of a decline in the measuring accuracy of the torque measured value due to, for example, deterioration of the electric tool 1 including the torque calculator 131. In addition, the torque true value, with which the torque measured value is to be compared, has been input in advance, and therefore, there is no need to measure the torque true value every time the calculating method is corrected. This allows the man-hours to be reduced at the time of correction and also allows the calculating method to be corrected more frequently. This contributes to improving the reliability of the torque measured value.

### (2) Details

Next, the electric tool system according to this embodiment will be described in further detail.

### (2.1) Configuration for Electric Tool System

First, a configuration for the electric tool system 10 according to this embodiment will be described in further detail with reference to the accompanying drawings.

As shown in FIG. 1, the electric tool system 10 includes the electric tool 1 and a management system 3. In addition, the electric tool system 10 further includes a communications cable C1 for connecting the electric tool 1 and the management system 3 by a wired method. That is to say, the electric tool 1 is provided separately from the management system 3 and may establish wired communication with the management system 3.

The electric tool 1 is a tool designed for use by business operators in, for example, factories and construction sites. The electric tool 1 may be used, for example, to perform the operation of mounting a designated member (such as a panel of a photovoltaic cell) onto a specified member (such as a frame) by fastening a work target (a fastening member such as a bolt or a screw). In this embodiment, the electric tool 1 is an electric impact wrench, for example. The impact wrench is designed to fasten a work target such as a bolt by applying impacting force thereto while turning the work target. Note that the electric tool 1 does not have to be such an electric impact wrench but may also be an electric impact screwdriver or even an electric torque wrench or an electric drill-screwdriver of the type that applies no impacting force.

The electric tool 1 includes the fastening unit 11 and the sensor unit 12. The electric tool 1 further includes a control unit 13, an operating unit 14, two communications units 15 (namely, a first communications unit 151 and a second communications unit 152), a power supply unit 16, and a storage unit 17. In addition, the electric tool 1 has a body 100 for housing or holding the respective components.

As shown in FIG. 3, the body 100 of the electric tool 1 includes a cylindrical barrel 101 and a grip 102 protruding radially from a circumferential surface of the barrel 101. An output shaft 113 protrudes from one axial end of the barrel 101. The output shaft 113 is provided with a socket 114, to which a bit (such as a torque wrench bit) is attached removably and selectively according to the type of the fastening member as the work target. To one end (lower end in FIG. 3) of the grip 102, a battery pack 103, housing the power supply unit 16, is attached removably.

The control unit 13 controls the respective operations of the fastening unit 11, the sensor unit 12, the first communications unit 151, the second communications unit 152, and other components. The control unit 13 includes a torque calculator 131, a calculation history generator 132, a rotation controller 134, and a communication method changer 135. Note that in FIG. 1, the torque calculator 131, the calculation history generator 132, the rotation controller 134, and the communication method changer 135 do not have substantive physical configurations but only represent respective functions to be performed by the control unit 13.

The control unit 13 is implemented as a microcontroller including one or more processors and a memory. In other words, the control unit 13 is implemented as a computer system including one or more processors and a memory. The computer system performs the functions of the control unit 13 by making the one or more processors execute a program stored in the memory. In this embodiment, the program is stored in advance in the memory of the control unit 13. Alternatively, the program may also be downloaded via a telecommunications line such as the Internet or distributed after having been stored in a non-transitory storage medium such as a memory card. The control unit 13 may be implemented as, for example, a field-programmable gate array (FPGA) or an application specific integrated circuit (ASIC). A microcontroller (such as a circuit board) performing the functions of the control unit 13 is housed inside the grip 102.

The fastening unit 11 includes the motor 111 (refer to FIG. 3) serving as a power source and a driver circuit (not shown), an impact mechanism 112, and the output shaft 113. The fastening unit 11 is configured to fasten the work target onto the specified member with the driving force generated by the motor 111. The driver circuit controls the rotation of the motor 111 in accordance with a control signal supplied from the control unit 13. The rotational power of the output shaft of the motor 111 is transmitted to the output shaft 113 via the impact mechanism 112. If the output torque is equal to or less than a predetermined level, the impact mechanism 112 reduces the rotational velocity of the output shaft of the motor 111 and transmits reduced rotational power to the output shaft 113. The impact mechanism 112 is configured to, when the output torque exceeds the predetermined level, apply impacting force to the output shaft 113 to turn the fastening member (such as a bolt) as the work target. As shown in FIG. 3, the motor 111 and the impact mechanism 112 are housed inside the barrel 101.

The operating unit 14 includes a trigger switch 141 provided for the grip 102. When the trigger switch 141 is pulled by the user, for example, an operating signal, of which the magnitude is proportional to the manipulative variable of the trigger switch 141 (i.e., the depth to which the trigger switch 141 has been pulled), is supplied to the control unit 13. In response to the operating signal supplied from the operating unit 14, the control unit 13 adjusts the velocity of a motor 111 such that the motor 111 rotates at a velocity corresponding to the operating signal.

The sensor unit 12 detects a physical quantity corresponding to the fastening torque with which the fastening unit 11 fastens the work target. The sensor unit 12 may include, for example, a magnetostrictive torque sensor 121 mounted on the output shaft 113. The magnetostrictive torque sensor 121 makes a coil, which is disposed in a non-rotating portion, detect a variation in magnetic permeability responsive to the strain caused upon the application of torque to the output shaft of the motor 111 and outputs a voltage signal proportional to the variation in magnetic permeability. That is to say, the torque sensor 121 outputs a voltage signal proportional to the strain generated to the output shaft of the motor 111.

The torque calculator 131 calculates a fastening torque measured value (i.e., torque measured value) by applying the voltage signal supplied from the sensor unit 12 to a preset calculating method. As used herein, the “calculating method” refers to a calculating formula for calculating the torque measured value using the voltage value as a parameter. The calculating method is stored in the storage unit 17 included in the electric tool 1. The torque calculator 131 transmits the torque measured value thus calculated to the rotation controller 134.

The calculation history generator 132 generates a calculation history that associates the torque measured value calculated by the torque calculator 131 with a time when the torque measured value has been calculated.

The rotation controller 134 controls, based on the torque measured value that the rotation controller 134 has received from the torque calculator 131, the fastening unit 11 to make the fastening torque equal to the preset torque value. When finding that the torque measured value has reached the preset torque value, for example, the rotation controller 134 causes the motor 111 to stop running. Optionally, the electric tool 1 may include a torque setting unit which may set the preset torque value at a variable value.

The first communications unit 151 is a communications module for establishing wired communication with the management system 3 via the communications cable C1.

The second communications unit 152 is a communications module for establishing wireless communication with the management system 3 using radio waves as a communication medium. That is to say, the electric tool 1 may establish wireless communication with the management system 3.

The second communications unit 152 is configured to establish short-range wireless communication in compliance with a communications protocol such as the Bluetooth® Low Energy (BLE) protocol. The “BLE” protocol is the name of a low power version of the Bluetooth® specification as a wireless personal area network (PAN) technology. Note that the second communications unit 152 does not have to be compliant with the BLE protocol but may also be compliant with any other communications protocol such as the ZigBee® protocol, the Specified Low Power Radio protocol (radio station requiring no licenses) on the 920 MHz band, or the Wi-Fi® protocol as long as the communications protocol requires no radio station licenses. In this embodiment, the second communications unit 152 communicates wirelessly with a receiver 4 of the management system 3.

The communication method changer 135 may change the method of communication between the electric tool 1 and the management system 3 from wireless communication to wired communication, and vice versa. That is to say, the communication method changer 135 may change the communications modules to be used by the electric tool 1 to communicate with the management system 3 from the first communications unit 151 to the second communications unit 152, and vice versa.

The power supply unit 16 includes a storage battery. The power supply unit 16 is housed inside the battery pack 103. The battery pack 103 is configured to house the power supply unit 16 inside a resin case. The storage battery of the power supply unit 16 may be charged by removing the battery pack 103 from the grip 102 and connecting the battery pack 103 thus removed to a charger. The power supply unit 16 supplies power required to operate an electric circuit including the control unit 13 and the motor 111 with the power stored in the storage battery.

The storage unit 17 is a device for storing information. The storage unit 17 may be, for example, a read-only memory (ROM), a random-access memory (RAM), or an electrically erasable programmable read-only memory (EEPROM). The storage unit 17 stores the calculating method by which the torque calculator 131 calculates the torque measured value. The storage unit 17 also stores a unique identification number for use to identify the electric tool 1.

As shown in FIG. 1, the electric tool 1 further includes a connector CN1 (connector CN11) to which the communications cable C1 is connected. The connector CN11 may be provided, for example, on the back of the body 100 (i.e., at the right end in FIG. 2). The communications cable C1 is a cable for connecting the electric tool 1 to the management system 3 by a wired method as described above. The connector CN11 is connected to the first communications unit 151. The first communications unit 151 establishes wired communication with the management system 3 via the communications cable C1 connected to the connector CN11.

The management system 3 includes the receiver 4 and a server 5.

The receiver 4 is a telecommunications device such as a personal computer in which a dedicated software program has been installed in advance, for example. Note that the receiver 4 does not have to be a personal computer but may also be any other type of telecommunications device such as a smartphone, a tablet computer, or a wearable terminal.

The receiver 4 includes a first communications unit 41, a second communications unit 42, a third communications unit 43, a control unit 44, a display unit 45, and a connector CN1 (connector CN12). The receiver 4 further includes the input unit 46.

The control unit 44 controls the respective operations of the first communications unit 41, the second communications unit 42, the third communications unit 43, the display unit 45, and other components. The control unit 44 may be implemented as, for example, a microcontroller including one or more processors and a memory. The control unit 44 may also be implemented as an FPGA or an ASIC, for example.

The display unit 45 includes a display device such as a liquid crystal display or an organic electroluminescent (EL) display.

The first communications unit 41 is a communications module for establishing wired communication with the electric tool 1 via the communications cable C1.

The second communications unit 42 is a communications module for establishing short-range wireless communication with the electric tool 1 in compliance with the same communications protocol as that of the second communications unit 152 of the electric tool 1.

The third communications unit 43 is connected to a wide-area communications network NT1 such as the Internet via a router, for example. The third communications unit 43 has the communication capability of communicating with the server 5 over the wide-area communications network NTT.

The connector CN12 is connected to the communications cable C1. The connector CN12 is connected to the first communications unit 41. The first communications unit 41 establishes wired communication with the electric tool 1 via the communications cable C1 connected to the connector CN12.

Note that the receiver 4 may change the communications modules from the first communications unit 41 to the second communications unit 42, and vice versa, to communicate with the electric tool 1 in accordance with an instruction given by the communication method changer 135 of the electric tool 1. That is to say, if the communication method changer 135 instructs that the electric tool 1 establish wired communication with (the receiver 4 of) the management system 3, then the receiver 4 establishes wired communication with the electric tool 1 using the first communications unit 41. On the other hand, if the communication method changer 135 instructs that the electric tool 1 establish wireless communication with (the receiver 4 of) the management system 3, then the receiver 4 establishes wireless communication with the electric tool 1 using the second communications unit 42.

The input unit 46 includes an input device 461 such as a keyboard or a mouse and a connection port 462 to which a storage medium such as a USB memory or an SD memory card may be connected.

The input unit 46 accepts the entry of the torque true value. Specifically, the input device 461 accepts the user's manual entry of the torque true value. In addition, the connection port 462 accepts the connection of a storage medium on which the user has stored the torque true value.

The input unit 46 accepts the entry of the torque true value that the user has entered using the input device 461. Alternatively, the input unit 46 may also accept the torque true value by being loaded with the torque true value read out from the storage medium that the user has connected to the connection port 462. This allows the user to enter, at any arbitrary timing, the torque true value that has been measured in advance by an arbitrary method.

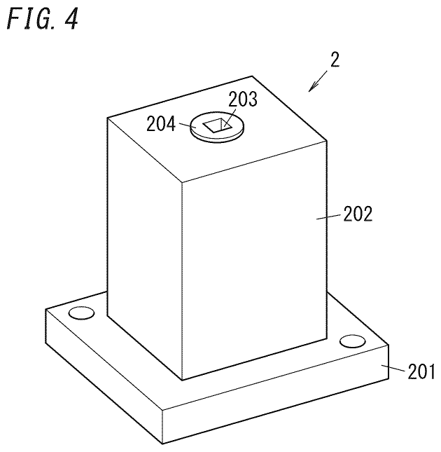

As used herein, the “torque true value” refers to the value of the torque applied from the electric tool 1 to the work target (fastening member), corresponding to the fastening operation (real operation) to be performed on the workplace by the electric tool 1, when the work target (fastening member) is fastened at the preset torque value corresponding to the real operation, as described above. The torque true value is measured by a torque measuring machine 2 (refer to FIG. 4), which is provided separately from the electric tool 1 and the management system 3, for example.

The torque measuring machine 2 includes a measuring unit (not shown), a pedestal 201, and a body 202. The pedestal 201 is a member for fixing the torque measuring machine 2 at any desired place such a desk or a wall. The pedestal 201 has the shape of a rectangular plate. Two through holes are provided through the pedestal 201 to pass fixing screws therethrough. Alternatively, the torque measuring machine 2 may have no pedestal 201. The body 202 is disposed on the upper surface of the pedestal 201 integrally with the pedestal 201. In this embodiment, the body 202 has the shape of a rectangular parallelepiped box. However, this shape is only an exemplary shape of the body 202 and should not be construed as limiting. Alternatively, the body 202 may also have any other shape such as a circular columnar shape. A measuring instrument 204 is provided for the body 202. The upper surface of the measuring instrument 204 has an insert hole 203 to which the bit of the electric tool 1 is inserted. The insert hole 203 has the same shape as a bit insert hole of the work target corresponding to the one to be actually used in the real operation. The measuring unit measures the force (i.e., fastening force) that the measuring instrument 204 receives from the bit of the electric tool 1 when the electric tool 1 is caused to operate (i.e., when the motor 111 is turned) with the preset torque value corresponding to the real operation with the bit inserted into the insert hole 203. The fastening force measured at this time will be the torque true value. That is to say, the torque true value is measured by the torque measuring machine 2 under the condition that allows the real operation to be simulated. The value of the torque true value thus measured is presented on the display unit (monitor screen) of a telecommunications device such as a personal computer connected to the torque measuring machine 2. Alternatively, the body 202 of the torque measuring machine 2 may be provided with a display unit having seven-segment light-emitting diodes (LEDs), for example. The user reads the torque true value presented on the display unit and enters the torque true value thus read into the management system 3 using the input unit 46. In this case, the user may enter the torque true value as a numerical value using, for example, a keyboard as an exemplary input device 461.

The measuring unit may include, for example, a strain gauge for measuring the strain produced by the measuring instrument 204. The measuring unit measures, based on the result of measurement by the strain gauge, the fastening force that the torque measuring machine 2 receives from the electric tool 1. Note that the measuring unit does not have to measure the fastening force using the strain gauge. Alternatively, the measuring unit may also use any other appropriate measuring method such as a magnetostrictive measuring method. Furthermore, the torque true value may be measured by any arbitrary method as described above. That is to say, the torque true value does not have to be measured using such a torque measuring machine 2.

The control unit 44 has the torque true value, of which the entry has been accepted by the input unit 46, transmitted from the third communications unit 43 to the server 5.

The server 5 includes a communications unit 51, a control unit 52, and a storage unit 53.

The communications unit 51 is a communications module connected to the wide-area communications network NT1 such as the Internet via the router, for example. The communications unit 51 has the communication capability of communicating with the receiver 4 over the wide-area communications network NT1.

The control unit 52 may be implemented as, for example, a microcontroller including one or more processors and a memory. The control unit 52 may also be implemented as an FPGA or an ASIC, for example. The control unit 52 controls the operation of the communications unit 51 and other components. The control unit 52 includes an association processor F1, an operations history generator F2, a comparison processor F3, a correction processor F4, a notifier F5, and a correction history generator F6. Note that in FIG. 1, the association processor F1, the operations history generator F2, the comparison processor F3, the correction processor F4, the notifier F5, and the correction history generator F6 do not have substantive physical configurations but only represent respective functions to be performed by the control unit 52. The specific functions and operations of the association processor F1, the operations history generator F2, the comparison processor F3, the correction processor F4, the notifier F5, and the correction history generator F6 will be described later in the “(2.2) Description of correction operation” section.

The storage unit 53 is a storage device for storing information. The storage unit 53 may be a ROM, a RAM, or an EEPROM, for example. The storage unit 53 stores, for example, the torque true value that the communications unit 51 has received from the third communications unit 43 of the receiver 4. In addition, the storage unit 53, as well as the storage unit 17 of the electric tool 1, also stores the calculating method by which the torque calculator 131 calculates the torque measured value.

### (2.2) Description of Correction Operation

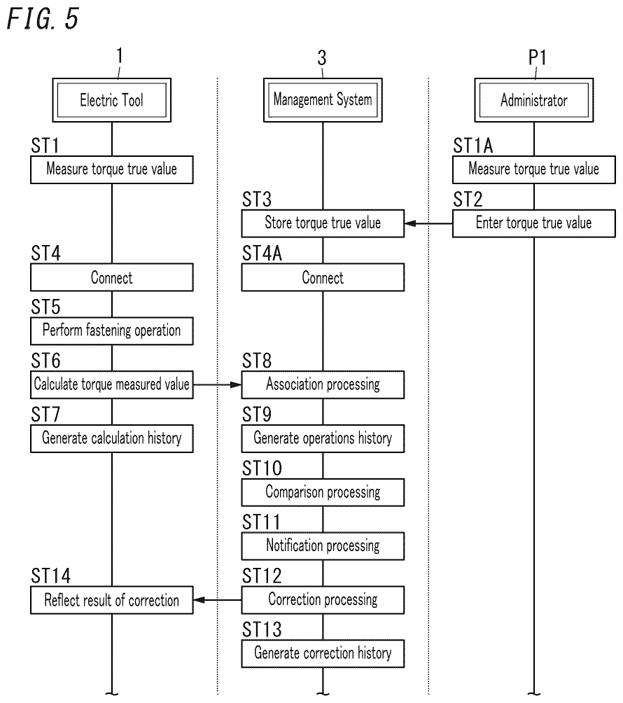

Next, it will be described with reference to FIG. 1 and FIG. 5 as a sequence chart how the electric tool system 10 performs the operation of correcting the method of calculating the torque measured value.

First, an administrator P1 of the electric tool system 10, for example, measures, using the electric tool 1 and the torque measuring machine 2, a torque true value corresponding to the fastening operation (real operation) to be performed by the electric tool 1 (in ST1 and ST1A). As used herein, the “torque true value corresponding to the real operation” refers to the value of the torque applied by the electric tool 1 (of which the torque value has been set at the preset torque value for the real operation) which is measured by the torque measuring machine 2.

The administrator P1 enters the torque true value thus measured into the receiver 4 by operating the input unit 46 (in ST2). At this time, the administrator also enters the identification number of the electric tool 1 into the receiver 4 in association with the torque true value. The torque true value entered by the administrator P1 is stored in the storage unit 53 of the server 5 (in ST3). In addition, the identification number of the electric tool 1 is also stored in the storage unit 53 in association with the torque true value. Note that the torque true value may be measured and entered, for example, in a different place from the workplace where the real operation is performed.

Next, the user of the electric tool 1 starts performing the operation of fastening the work target (real operation) at the workplace using the electric tool 1. Note that the user of the electric tool 1 who performs the real operation may be either the same as, or different from, the administrator P1, whichever is appropriate. In this case, the real operation is supposed to be the operation of fastening a single fastening member as an example. However, the real operation does not have to be the operation of fastening the single fastening member but may also be the operation of fastening a plurality of fastening members.

First, the user who performs the real operation connects the electric tool 1 to the management system 3 (in ST4 and ST4A). Specifically, the user connects the electric tool 1 to the receiver 4 of the management system 3. In this step, the user connects, by wired method, the electric tool 1 to the receiver 4 via the communications cable C1. More specifically, the user connects one end of the communications cable C1 to the connector CN11 of the electric tool 1 and also connects the other end of the communications cable C1 to the connector CN12 of the receiver 4. The communication method changer 135 of the electric tool 1 is configured to, when detecting that the electric tool 1 and the receiver 4 have been connected via the communications cable C1, for example, set the first communications unit 151 to be the communications module to be used by the electric tool 1 for communicating with the receiver 4 to establish wired communication between the electric tool 1 and the receiver 4. The communication method changer 135 may be configured to, when the electric tool 1 and the receiver 4 are not connected via the cable, set the second communications unit 152 to be the communications module to be used by the electric tool 1 for communicating with the receiver 4 to establish wireless communication between the electric tool 1 and the receiver 4. In this case, the receiver 4 and the server 5 are connected to each other over the wide-area communications network NT1 such as the Internet. Thus, when the electric tool 1 and the receiver 4 are connected, the electric tool 1 and the server 5 are also connected via the receiver 4.

Once the electric tool 1 and the receiver 4 are connected, the server 5 transmits the calculating method (such as information about the calculating formula), which is stored in the storage unit 53, to the electric tool 1 via the receiver 4. The electric tool 1 stores, in the storage unit 17, the calculating method thus received. Alternatively, the calculating method may also be stored in advance in the storage unit 17 of the electric tool 1 and the storage unit 53 of the server 5 before the electric tool 1 and the receiver 4 are connected to each other.

After having connected the electric tool 1 and the receiver 4 to each other, the user performs the real operation using the electric tool 1 (in ST5). In this step, the torque calculator 131 of the electric tool 1 calculates the torque measured value of the electric tool 1 at the time of the real operation by applying the voltage signal supplied from the sensor unit 12 to the calculating method stored in the storage unit 17 (in ST6).

The calculation history generator 132 of the electric tool 1 generates a calculation history that associates the torque measured value calculated by the torque calculator with the time when the torque measured value has been calculated (in ST7). The calculation history calculated by the calculation history generator 132 is stored in the storage unit 17 of the electric tool 1. Note that the time when the torque measured value has been calculated may be acquired, for example, by the clocking function of the control unit 13.

When the real operation is done, the control unit 13 has the specific details of the real operation, including the torque measured value, and the identification number unique to the electric tool 1 which is stored in the storage unit 17 transmitted to the server 5 via the receiver 4. Examples of the specific details of the real operation may include not only the torque measured value but also various other types of information about the type of the work target, the coordinates of the workplace where the real operation has been performed, and the amount of time it has taken to have the real operation done. The specific details of the real operation and the identification number are transmitted from the electric tool 1 to the receiver 4 via the wired communication between the first communications unit 151 of the electric tool 1 and the first communications unit 41 of the receiver 4 and also transmitted from the receiver 4 to the server 5 via the communication over the wide area communications network NT1 between the third communications unit 43 of the receiver 4 and the communications unit 51 of the server 5.

When the communications unit 51 of the server 5 receives, from the electric tool 1, the specific details of the real operation and the identification number of the electric tool 1, the association processor F1 of the server 5 performs the processing of associating the electric tool 1 that has performed the real operation with the torque true value (in ST8). Specifically, the association processor F1 searches the storage unit 53 for an identification number matching the identification number that has been received from the electric tool 1 that has performed the real operation, finds such an identification number, and sets a torque true value associated with the matching identification number as the torque true value of the electric tool 1 that has performed the real operation. Note that if the preset torque value of the electric tool 1 is changeable, then the association processor F1 preferably sets a torque true value associated with the electric tool 1 that has performed the real operation which has been measured at the same preset torque value as the one for the real operation as the torque true value for the electric tool 1 that has performed the real operation.

Also, at this time, the operations history generator F2 of the server 5 generates an operations history that associates the specific details of the real operation performed by the electric tool 1 which have been received via communication with the electric tool 1 with the time when the real operation has been performed (in ST9). The operations history generated by the operations history generator F2 is stored in the storage unit 53 of the server 5. As used herein, the “time when the real operation has been performed” refers to, for example, a time when the server 5 receives the specific details of the real operation from the electric tool 1 after the real operation has been performed and may be acquired by the clocking function of the control unit 13, for example. Alternatively, the “time when the real operation has been performed” may also be a time when the electric tool 1 has started performing the real operation. In that case, the time when the electric tool 1 has started performing the real operation is acquired by the clocking function of the control unit 13 of the electric tool 1 and transmitted as a part of the specific details of the real operation to the server 5.

Next, the comparison processor F3 of the server 5 compares the torque measured value when the electric tool 1 has performed the real operation with the torque true value of the electric tool 1 to calculate the difference ΔT between these two values (in ST10). Note that the “difference” as used herein means the absolute value of the difference between the torque measured value and the torque true value.

If the difference ΔT is greater than a second threshold value ΔTh2, then the notifier F5 notifies the user of the electric tool 1 of that fact (in ST11).

The notifier F5 may make the notification using any appropriate means. For example, the control unit 52 may have a notification signal transmitted to the receiver 4 via the communications unit 51 to have any desired alert message displayed on the display unit 45 of the receiver 4. The alert message may indicate that there is a difference between the torque measured value measured by the electric tool 1 and the torque true value (i.e., that the method of calculating the torque measured value should be corrected).

The destination to which the notifier F5 transmits the notification signal does not have to be the receiver 4 but may also be the electric tool 1 or an external device outside of the electric tool system 10. Examples of such external devices outside of the electric tool system 10 include a mobile telecommunications device (such as a tablet computer or a smartphone) carried by the user of the electric tool 1 with him or her. Also, the means for notification does not have to be displaying such an alert message but may also be any other appropriate means such as emitting light, producing vibration, or emitting an alarm sound from an appropriate device.

If the difference ΔT is greater than the second threshold value ΔTh2, then the correction processor F4 corrects the torque measured value calculating method to be used by the torque calculator 131 to make the difference ΔT between the torque measured value of the electric tool 1 and the torque true value equal to or less than the first threshold value ΔTh1 (in ST12). In this case, the first threshold value ΔTh1 and the second threshold value ΔTh2 are real numbers equal to or greater than zero. In addition, the first threshold value ΔTh1 is equal to or less than the second threshold value ΔTh2. For example, suppose the first threshold value ΔTh1 is set at 0.5 N·m and the second threshold value ΔTh2 is set at 1.5 N·m. At that time, the torque measured value at the time of the real operation is supposed to be 100 N·m and the torque true value for the real operation is supposed to be 120 N·m. Then, the difference ΔT between the torque true value and the torque measured value is 20 N·m, which is greater than 1.5 N·m that is the second threshold value ΔTh2. Thus, the correction processor F4 corrects the calculating method to make the difference ΔT equal to or less than 0.5 N·m that is the first threshold value ΔTh1. That is to say, the torque measured value calculated by the corrected calculating method will be a value falling within the range from 119.5 N·m and 120.5 N·m.

Note that the calculating method herein refers to a calculating formula for calculating the torque measured value using, as a parameter, the physical quantity (such as a voltage value) measured by the sensor unit 12 as described above. The calculating method may be corrected by, for example, changing the coefficients and degrees of the respective terms that form the calculating formula.

When the calculating method has been corrected by the correction processor F4, the correction history generator F6 generates a correction history that associates, for example, the specific details of the correction including the calculating methods before and after the correction and the difference ΔT with the electric tool 1 as the target of the correction and the time when the correction has been made (in ST13).

In addition, the correction processor F4 reflects the result of the correction to the calculating method on the electric tool 1 (in ST14). Specifically, the correction processor F4 has the corrected method of calculating the torque measured value (hereinafter referred to as a “corrected calculating method”) transmitted from the communications unit 51 to the electric tool 1 via the receiver 4. The first communications unit 151 of the electric tool 1 receives the corrected calculating method that has been transmitted from the communications unit 51. Note that if the electric tool 1 and the receiver 4 are communicating wirelessly with each other, then the second communications unit 152 of the electric tool 1 receives the corrected calculating method. The corrected calculating method received by either the first communications unit 151 or the second communications unit 152 is stored in the storage unit 17. At this time, the calculating method already stored in the storage unit 17 which has not been corrected yet is overwritten by the corrected calculating method. That is to say, once either the first communications unit 151 or the second communications unit 152 receives the corrected calculating method, the torque calculator 131 will calculate the torque measured value by the corrected calculating method from that time on. Note that if the difference ΔT becomes greater than the second threshold value ΔTh2 again after the calculating method has been corrected, then the calculating method will be corrected once again.

As can be seen from the foregoing description, the electric tool system 10 according to this embodiment corrects, using the torque measured value that has been entered in advance into the input unit 46, the method of calculating the torque measured value for the real operation performed by the electric tool 1. That is why if the calculating method for the real operation is to be corrected every time a constant period of time passes, for example, there is no need to measure the torque true value every time, thus contributing to improving the reliability of the torque measured value while reducing an increase in man-hours for the user.

### (3) Variations

Note that the embodiment described above is only an exemplary one of various embodiments of the present disclosure and should not be construed as limiting. Rather, the exemplary embodiment may be readily modified in various manners depending on a design choice or any other factor without departing from the scope of the present disclosure. The functions of the electric tool system 10 may also be implemented as, for example, an electric tool management method, a (computer) program, or a non-transitory storage medium on which the program is stored.

An electric tool management method according to the exemplary embodiment described above includes detection processing, torque calculation processing, operating command input processing, comparison processing, and correction processing. The detection processing includes detecting a physical quantity corresponding to fastening torque with which the fastening unit 11 fastens a work target onto a specified member with driving force generated by a power source. The torque calculation processing includes calculating a torque measured value by applying a result of detection of the physical quantity obtained in the detection processing to a calculating method. The operating command input processing includes accepting entry of a torque true value. The comparison processing includes comparing the torque measured value with the torque true value. The correction processing includes making, based on a result of comparison obtained in the comparison processing, correction to the calculating method to make a difference ΔT between the torque measured value and the torque true value equal to or less than a predetermined threshold value (first threshold value ΔTh1). A (computer) program according to the exemplary embodiment described above is designed to cause a computer system to perform the above-described electric tool management method.

Next, variations of the exemplary embodiment will be enumerated one after another. Note that the variations to be described below may be adopted in combination as appropriate.

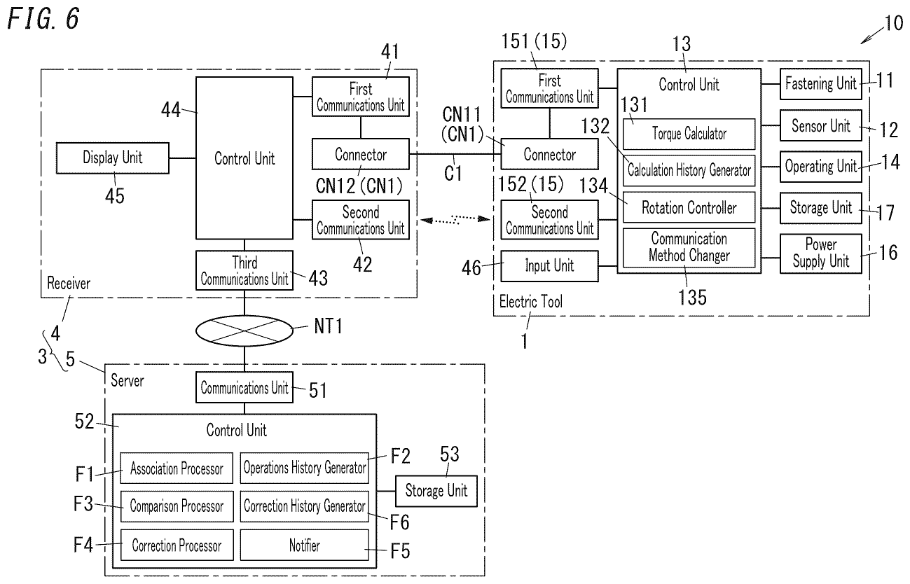

The input unit 46 needs to be provided for at least one of the electric tool 1 or the management system 3. For example, the input unit 46 may be provided for the electric tool 1 as shown in FIG. 6. In that case, the input unit 46 may be, for example, exposed on the surface of the body 100 of the electric tool 1 and include ten keys for accepting the entry of a numerical value by the user. The torque true value entered through the input unit 46 of the electric tool 1 is transmitted to the server 5 via the receiver 4.

Also, if the electric tool 1 is used for performing multiple types of real operations, then the input unit 46 may also be configured to accept the entry of a plurality of torque true values for the multiple types of real operations, respectively. In that case, the comparison processor F3 compares the torque measured value of the real operation that has been performed by the electric tool 1 with a torque true value belonging to the plurality of torque true values which is associated with the real operation that has been performed by the electric tool 1. According to this configuration, when the user successively corrects the calculating methods for the multiple types of real operations one after another, for example, there is no need to measure the plurality of torque true values respectively associated with the multiple types of real operations every time he or she makes the correction. This contributes to improving the reliability of the torque measured values respectively associated with the multiple types of real operations while reducing an increase in man-hours for the user.

Furthermore, the input unit 46 may also be configured to, when the electric tool system 10 includes a plurality of electric tools 1, accept the entry of a plurality of torque true values respectively associated with the plurality of electric tools 1. In that case, the comparison processor F3 compares the torque measured value of the real operation that has been performed by each of the plurality of electric tools 1 with one of the plurality of torque true values which is associated with the electric tool 1 that has performed the real operation. This configuration allows a single management system to correct the torque measured value calculating method for the plurality of electric tools 1, thus contributing to simplifying the configuration of the electric tool system 10.

The physical quantity measured by the sensor unit 12 may also be a current flowing through the motor 111 (i.e., a motor current), for example. In that case, the torque calculator 131 calculates the torque measured value by applying a current signal supplied from the sensor unit 12 to a preset calculating method.

The electric tool system 10 according to the present disclosure includes a computer system in its control unit 52, for example. The computer system may include a processor and a memory as principal hardware components thereof. The functions of the control unit 52 according to the present disclosure may be performed by making the processor execute a program stored in the memory of the computer system. The program may be stored in advance in the memory of the computer system. Alternatively, the program may also be downloaded through a telecommunications line or be distributed after having been recorded in some non-transitory storage medium such as a memory card, an optical disc, or a hard disk drive, any of which is readable for the computer system. The processor of the computer system may be made up of a single or a plurality of electronic circuits including a semiconductor integrated circuit (IC) or a large-scale integrated circuit (LSI). As used herein, the “integrated circuit” such as an IC or an LSI is called by a different name depending on the degree of integration thereof. Examples of the integrated circuits such as an IC or an LSI include integrated circuits called a “system LSI,” a “very-large-scale integrated circuit (VLSI),” and an “ultra-large-scale integrated circuit (ULSI).” Optionally, an FPGA to be programmed after an LSI has been fabricated or a reconfigurable logic device allowing the connections or circuit sections inside of an LSI to be reconfigured may also be adopted as the processor. Those electronic circuits may be either integrated together on a single chip or distributed on multiple chips, whichever is appropriate. Those multiple chips may be aggregated together in a single device or distributed in multiple devices without limitation. As used herein, the “computer system” includes a microcontroller including one or more processors and one or more memories. Thus, the microcontroller may also be implemented as a single or a plurality of electronic circuits including a semiconductor integrated circuit or a large-scale integrated circuit.

### (Recapitulation)

As can be seen from the foregoing description, an electric tool system (10) according to a first aspect includes a fastening unit (11), a sensor unit (12), a torque calculator (131), an input unit (46), a comparison processor (F3), and a correction processor (F4). The fastening unit (11) fastens a work target onto a specified member with driving force generated by a power source. The sensor unit (12) detects a physical quantity corresponding to fastening torque with which the fastening unit (11) fastens the work target. The torque calculator (131) calculates a torque measured value by applying a result of detection of the physical quantity by the sensor unit (12) to a calculating method. The input unit (46) accepts entry of a torque true value. The comparison processor (F3) compares the torque measured value with the torque true value. The correction processor (F4) makes, based on a result of comparison made by the comparison processor (F3), correction to the calculating method to make a difference (ΔT) between the torque measured value and the torque true value equal to or less than a predetermined threshold value (ΔTh1).

This aspect may contribute to improving the reliability of the torque measured value.

In an electric tool system (10) according to a second aspect, which may be implemented in conjunction with the first aspect, the input unit (46) accepts, as the entry, at least one of a user's manual entry or connection of a storage medium on which the torque true value is stored.

This aspect allows the user to enter, at any timing, the torque true value that has been measured in advance by an arbitrary method.

An electric tool system (10) according to a third aspect, which may be implemented in conjunction with the first or second aspect, includes an electric tool (1) and a management system (3). The electric tool (1) includes the fastening unit (11) and the sensor unit (12). The management system (3) includes the input unit (46), the comparison processor (F3), and the correction processor (F4). The electric tool (1) is provided separately from the management system (3) and may establish wired communication with the management system (3).

This aspect allows the calculating method to be corrected even in a situation where no wireless environment is available.

An electric tool system (10) according to a fourth aspect, which may be implemented in conjunction with the third aspect, further includes a communications cable (C1) for use to connect the electric tool (1) to the management system (3) by a wired method.

This aspect allows the calculating method to be corrected even in a situation where no wireless environment is available.

In an electric tool system (10) according to a fifth aspect, which may be implemented in conjunction with the fourth aspect, at least one of the electric tool (1) or the management system (3) includes a connector (CN1) to which the communications cable (C1) is connected.

This aspect allows the calculating method to be corrected even in a situation where no wireless environment is available.

In an electric tool system (10) according to a sixth aspect, which may be implemented in conjunction with any one of the third to fifth aspects, the electric tool (1) further includes the torque calculator (131) and a communications unit (15). The communications unit (15) receives, from the management system (3), a corrected calculating method as a version of the calculating method subjected to the correction by the correction processor (F4). The torque calculator (131) calculates, in response to reception of the corrected calculating method at the communications unit (15), the torque measured value by the corrected calculating method.

This aspect enables maintaining the reliability of the torque measured value by updating the calculating method.

In an electric tool system (10) according to a seventh aspect, which may be implemented in conjunction with any one of the third to sixth aspects, the input unit (46) is provided for at least one of the electric tool (1) or the management system (3).

This aspect contributes to improving the reliability of the torque measured value.

In an electric tool system (10) according to an eighth aspect, which may be implemented in conjunction with any one of the third to seventh aspects, the electric tool (1) may establish wireless communication with the management system (3).

This aspect allows the calculating method to be corrected even if the electric tool (1) is located distant from the management system (3).

In an electric tool system (10) according to a ninth aspect, which may be implemented in conjunction with the eighth aspect, a method of the communication between the electric tool (1) and the management system (3) is changeable from the wireless communication to the wired communication, and vice versa.

This aspect allows an appropriate communication method to be selected depending on the environment where the electric tool (1) and the management system (3) are currently put.

In an electric tool system (10) according to a tenth aspect, which may be implemented in conjunction with any one of the third to ninth aspects, the management system (3) further includes an operations history generator (F2) that generates an operations history that associates specific details, received through the communication with the electric tool (1), of the operation performed by the electric tool (1) with a time when the operation has been performed.

This aspect allows the user to recognize, along the time series, the specific details of the operations performed by the electric tool (1).

In an electric tool system (10) according to an eleventh aspect, which may be implemented in conjunction with any one of the third to tenth aspects, the management system (3) further includes a correction history generator (F6) that generates a correction history that associates, with each other, specific details of the correction made by the correction processor (F4) to the calculating method, the electric tool (1) subjected to the correction, and a time when the correction has been made.

This aspect allows the user to recognize, along the time series, the specific details of the correction made to the calculating method and the electric tool (1) subjected to the correction.

In an electric tool system (10) according to a twelfth aspect, which may be implemented in conjunction with any one of the third to eleventh aspects, the electric tool (1) further includes a calculation history generator (132) that generates a calculation history that associates the torque measured value calculated by the torque calculator (131) with a time when the torque measured value has been calculated.

This aspect allows the user to recognize, along the time series, a variation in the torque measured value.

An electric tool management method according to a thirteenth aspect includes detection processing, torque calculation processing, operating command input processing, comparison processing, and correction processing. The detection processing includes detecting a physical quantity corresponding to fastening torque with which a fastening unit (11) fastens a work target onto a specified member with driving force generated by a power source. The torque calculation processing includes calculating a torque measured value by applying a result of detection of the physical quantity obtained in the detection processing to a calculating method. The operating command input processing includes accepting entry of a torque true value. The comparison processing includes comparing the torque measured value with the torque true value. The correction processing includes making, based on a result of comparison obtained in the comparison processing, correction to the calculating method to make a difference (ΔT) between the torque measured value and the torque true value equal to or less than a predetermined threshold value (ΔTh1).

This aspect contributes to improving the reliability of the torque measured value.

A program according to a fourteenth aspect is designed to cause a computer system to perform the electric tool management method according to the thirteenth aspect.

This aspect contributes to improving the reliability of the torque measured value.

Note that these are not the only aspects of the present disclosure but various configurations (including variations) of the electric tool system (10) according to the exemplary embodiment described above may also be implemented as, for example, an electric tool management method, a (computer) program, or a non-transitory storage medium on which the program is stored.

Note that the constituent elements according to the second to twelfth aspects are not essential constituent elements for the electric tool system (10) but may be omitted as appropriate.

### REFERENCE SIGNS LIST

1 Electric Tool
3 Management System
10 Electric Tool System
11 Fastening Unit
12 Sensor Unit
15 Communications Unit
46 Input Unit
131 Torque Calculator
132 Calculation History Generator
C1 Communications Cable
CN1 Connector
F2 Operations History Generator
F3 Comparison Processor
F4 Correction Processor
F6 Correction History Generator
ΔT Difference
ΔTh1 First Threshold Value

1. An electric tool system comprising:
a fastening unit configured to fasten a work target onto a specified member with driving force generated by a power source;
a sensor unit configured to detect a physical quantity corresponding to fastening torque with which the fastening unit fastens the work target;
a torque calculator configured to calculate a torque measured value by applying a result of detection of the physical quantity by the sensor unit to a calculating method;
an input unit configured to accept entry of a torque true value;
a comparison processor configured to compare the torque measured value with the torque true value; and
a correction processor configured to make, based on a result of comparison made by the comparison processor, correction to the calculating method to make a difference between the torque measured value and the torque true value equal to or less than a predetermined threshold value.

2. The electric tool system of claim 1, wherein
the input unit is configured to accept, as the entry, at least one of a user's manual entry or connection of a storage medium on which the torque true value is stored.

3. The electric tool system of claim 1, comprising:
an electric tool including the fastening unit and the sensor unit; and
a management system including the input unit, the comparison processor, and the correction processor, wherein
the electric tool is provided separately from the management system and is configured to establish wired communication with the management system.

4. The electric tool system of claim 3, further comprising a communications cable for use to connect the electric tool to the management system by a wired method.

5. The electric tool system of claim 4, wherein
at least one of the electric tool or the management system includes a connector to which the communications cable is connected.

6. The electric tool system of claim 3, wherein
the electric tool further includes:
the torque calculator; and
a communications unit configured to receive, from the management system, a corrected calculating method as a version of the calculating method subjected to the correction by the correction processor, wherein
the torque calculator is configured to, in response to reception of the corrected calculating method at the communications unit, calculate the torque measured value by the corrected calculating method.

7. The electric tool system of claim 3, wherein
the input unit is provided for at least one of the electric tool or the management system.

8. The electric tool system of claim 3, wherein
the electric tool is configured to establish wireless communication with the management system.

9. The electric tool system of claim 8, wherein
a method of the communication between the electric tool and the management system is changeable from the wireless communication to the wired communication, and vice versa.

10. The electric tool system of claim 3, wherein
the management system further includes an operations history generator configured to generate an operations history that associates specific details, received through the communication with the electric tool, of the operation performed by the electric tool with a time when the operation has been performed.

11. The electric tool system of claim 3, wherein
the management system further includes a correction history generator configured to generate a correction history that associates, with each other, specific details of the correction made by the correction processor to the calculating method, the electric tool subjected to the correction, and a time when the correction has been made.

12. The electric tool system of claim 3, wherein
the electric tool further includes a calculation history generator configured to generate a calculation history that associates the torque measured value calculated by the torque calculator with a time when the torque measured value has been calculated.

13. An electric tool management method comprising:
detection processing including detecting a physical quantity corresponding to fastening torque with which a fastening unit fastens a work target onto a specified member with driving force generated by a power source;
torque calculation processing including calculating a torque measured value by applying a result of detection of the physical quantity obtained in the detection processing to a calculating method;
operating command input processing including accepting entry of a torque true value;
comparison processing including comparing the torque measured value with the torque true value; and
correction processing including making, based on a result of comparison obtained in the comparison processing, correction to the calculating method to make a difference between the torque measured value and the torque true value equal to or less than a predetermined threshold value.

14. A non-transitory storage medium in which a program is stored, the program being designed to cause a computer system to perform the electric tool management method of claim 13.

15. The electric tool system of claim 2, comprising:
an electric tool including the fastening unit and the sensor unit; and
a management system including the input unit, the comparison processor, and the correction processor, wherein
the electric tool is provided separately from the management system and is configured to establish wired communication with the management system.

16. The electric tool system of claim 4, wherein
the electric tool further includes:
the torque calculator; and
a communications unit configured to receive, from the management system, a corrected calculating method as a version of the calculating method subjected to the correction by the correction processor, wherein
the torque calculator is configured to, in response to reception of the corrected calculating method at the communications unit, calculate the torque measured value by the corrected calculating method.

17. The electric tool system of claim 5, wherein
the electric tool further includes:
the torque calculator; and
a communications unit configured to receive, from the management system, a corrected calculating method as a version of the calculating method subjected to the correction by the correction processor, wherein
the torque calculator is configured to, in response to reception of the corrected calculating method at the communications unit, calculate the torque measured value by the corrected calculating method.

18. The electric tool system of claim 4, wherein
the input unit is provided for at least one of the electric tool or the management system.

19. The electric tool system of claim 5, wherein
the input unit is provided for at least one of the electric tool or the management system.

20. The electric tool system of claim 6, wherein
the input unit is provided for at least one of the electric tool or the management system.
